(19) United States
(12) Patent Application Publication
(10) Pub. No.: US 2026/0133118 A1
(43) Pub. Date: May 14, 2026

(54) FIBEROPTIC FREE SPACE INTERFEROMETER WITH PARALLEL ELECTROPHORETIC MOBILITY DETECTION

(71) Applicant: Wyatt Technology, LLC, Goleta, CA (US)

(72) Inventor: Steven P. Trainoff, Santa Barbara, CA (US)

(21) Appl. No.: 19/382,935

(22) Filed: Nov. 7, 2025

Related U.S. Application Data
(60) Provisional application No. 63/718,515, filed on Nov. 8, 2024.

(51) Int. Cl. G01N 15/1434; G01N 15/00; G01N 15/1404

(52) U.S. Cl. CPC G01N 15/1434; G01N 15/1404; G01N 2015/03

(57) ABSTRACT

An electrophoretic mobility apparatus comprising a light source, a sample fiberoptic path along which a first source of light including a sample beam travels from the light source, a sample cell along the sample fiberoptic path that receives the first source of light, a reference fiberoptic path along which a second source of light including a reference beam travels from the light source; a lens along the reference fiberoptic path that forms a plane parallel beam from the second source of light; a modulator along the reference fiberoptic path that provides frequency control of the second source of light, a beamsplitter combines the reference beam with a fraction of light scattered from the particles and forms a coherent beam, and a detector comprising an array of photo detector elements onto which the coherent beam is incident, wherein each detector element produces time varying signals from the coherent beam.

### RELATED APPLICATIONS

This application claims priority to U.S. Provisional Patent Application No. 63/718,515 filed on Nov. 8, 2024 and titled “Fiberoptic Free Space Interferometer with Parallel Electrophoretic Mobility Detection,” the entirety of which is incorporated herein by reference.

This application is related to U.S. Provisional Patent Application No. 63/466,211 filed on May 12, 2023 and titled “Apparatus to Measure Electrophoretic Mobility,” the entirety of which is incorporated herein by reference.

### BACKGROUND

The present disclosure relates generally to electrophoretic mobility, and more specifically, to an apparatus that includes a fiberoptic interferometer with parallel, free space detection for measuring the electrophoretic mobility of particles, e.g., macroparticles, nanoparticles, or the like.

Solutions containing solutes such as molecules, viruses, nanoparticles, liposomes, etc. are often measured following separation by chromatographic techniques or other types of preparative techniques. Online detectors such as UV Absorption (UV), Multi-angle light scattering (MALS), Differential refractive index detectors (DRI), Differential viscometers (DV), evaporative light scattering detectors, (ELSD), Charged Aerosol detectors (CAD), and Mass spectrometers (MS) can provide real-time characterization of fractionated samples. When used singly, or as part of a multi-detector analysis, they provide information about the sample's size, molecular weight, viscosity, and composition. However, although electrophoretic mobility instruments can be used on batch samples, or collected fractions of a chromatographic separation, there does not exist any mobility detector that is fast enough, or sensitive enough, to act as an online detector. The subject of this disclosure is to present a design that is dramatically more sensitive than existing electrophoretic mobility instruments and fast enough that it can be used as an online detector, in addition to its traditional use as a batch detector.

Several methods have been developed and are available for measuring electrophoretic mobility. One technique is to carry out the free-solution measurements in a batch mode where a sample containing macromolecules of interest is loaded into an apparatus, an AC (alternating current) electric field is applied, and the electrophoretic velocity is directly measured using a heterodyne light scattering method. One limitation of this technique is that to minimize the sample volume required to perform a measurement the electrodes that provide the electric field are necessarily close to the region where the optical measurement is performed. Applying the field that drives the electrophoretic flow is an invasive process. At the surface of the electrodes, the solvent undergoes electrolysis giving rise to gas creation and the generation of highly reactive species that damage the sample. For example, if the mobile phase includes sodium chloride, then one of the byproducts of the solvent electrolysis is sodium hypochlorite (bleach) that degrades delicate samples.

While this approach is less complex and more serviceable than other techniques, interferometers used for performing such batch mode measurements are generally configured with a single detection channel, and substantially slower than light scattering instruments having parallel optical channels for performing simultaneous electrophoretic mobility and size measurements of nanoparticles and the like. However, such instruments include complex optical assemblies that are difficult and expensive to manufacture, for example, described in U.S. Pat. No. 8,525,991 entitled “Method to measure particle mobility in solution with scattered and unscattered light,” the entirety of which is incorporated herein by reference.

### SUMMARY

In one aspect, an electrophoretic mobility apparatus comprises a light source; a sample fiberoptic path along which a first source of light including a sample beam travels from the light source; a sample cell along the sample fiberoptic path that receives the first source of light, wherein the sample beam passes through the sample cell as an unscattered portion, and a scattered fraction of the sample beam scatters from particles in an aliquot in the sample cell; and wherein the sample beam and a fraction of the sample scattered from the particles in the aliquot leaves the sample cell; a reference fiberoptic path along which a second source of light including a reference beam travels from the light source; a lens along the reference fiberoptic path that forms a plane parallel beam from the second source of light; at least one modulator along the reference fiberoptic path that provides frequency control of the second source of light; a beamsplitter in free space that combines the reference beam with the fraction of light scattered from the particles and forms a coherent beam; and a detector comprising an array of photo detector elements onto which the coherent beam is incident, wherein each detector element produces time varying signals from the coherent beam.

In some embodiments, the electrophoretic mobility apparatus further comprises a fiber splitter that includes a first output port to the sample fiberoptic path and a second output port to the reference fiberoptic path; a first removable coupling between the second output port of the fiber splitter and the sample cell; and a second removable coupling between the first output port of the fiber splitter and the at least one modulator.

In some embodiments, the electrophoretic mobility apparatus further comprises a collimating lens that directs the first source of light into the sample cell.

In some embodiments, the electrophoretic mobility apparatus further comprises a collimating lens at an output of the at least one modulator that directs the second source of light into the beamsplitter.

In some embodiments, the electrophoretic mobility apparatus further comprises a collimating lens at an output of the sample cell that forms a parallel beam from the first source of light directed at the beamsplitter, the collimating lens collimating the scattered fraction of the sample beam and the unscattered portion of the sample beam.

In some embodiments, the electrophoretic mobility apparatus further comprises a mirror that reflects the unscattered portion of the sample beam combined with the scattered fraction to the beamsplitter.

In some embodiments, the electrophoretic mobility apparatus further comprises a mirror that reflects the reference beam to the beamsplitter.

In some embodiments, the collimating lens is positioned one focal length from a center of the cell so that light that scatters from the center of the cell makes a plane parallel beam from the lens to the detector.

In some embodiments, the electrophoretic mobility apparatus further comprises a data processor that measures light intensity values of the coherent beam from the beamsplitter, the light intensity values at each of a plurality of photo detector elements placed in the path of the coherent beam.

In some embodiments, the sample cell is an interchangeable unit.

In some embodiments, the detector comprises a two-dimensional array. In some embodiments, the detector comprises a one-dimensional array.

In another aspect, an electrophoretic mobility apparatus comprises a fiberoptic interferometer that divides a coherent monochromatic light beam into a sample beam that passes through a sample and a reference beam, the fiberoptic interferometer including: a reference arm having at least one modulator that provides frequency control of the reference beam; and a sample arm having a sample cell that holds the sample; and a parallel, free space detection system comprising: a beamsplitter in free space that combines the reference beam with the fraction of light scattered from the particles and forms a coherent beam; and a detector comprising an array of photo detector elements onto which the coherent beam is incident, wherein each detector element produces time varying signals from the coherent beam.

In another aspect, an apparatus, comprises a laser; a fiber having an input for receiving an output of light from the laser; a fiber splitter; first and second acousto-optic modulators at a first output of the fiber splitter that transmit a reference beam of the output of light; an optics element at an output of the first and second acousto-optic modulators; a beam splitter in free space that combines the reference beam with a sample beam output in parallel from a second output of the fiber splitter to form a coherent beam; and a detector that produces time varying signals from the coherent beam.

### BRIEF DESCRIPTION OF THE DRAWINGS

FIG. 1 is a block diagram of an electrophoretic mobility instrument, in accordance with some embodiments.

FIG. 2 is a schematic diagram of a layout of a sample cell and a detector of the electrophoretic mobility instrument of FIG. 1, in accordance with some embodiments.

FIG. 3 is a block diagram of the electrophoretic mobility instrument of FIGS. 1 and 2 operating as an online mobility detector with a separation system, in accordance with some embodiments.

FIG. 4 is a block diagram of an electrophoretic mobility instrument, in accordance with other embodiments.

FIG. 5 is a block diagram of an electrophoretic mobility instrument, in accordance with other embodiments.

FIG. 6 is a graph of results of an SEC elution with a protein mixture eluting from a chromatography column with online mobility detection performed by an electrophoretic mobility instrument, in accordance with some embodiments.

FIG. 7 is a graph of a mobility spectrum illustrating a weight fraction of each mobility range of a plurality of sample species processed by an electrophoretic mobility instrument, in accordance with some embodiments.

FIG. 8 is a table of results of a comparison of measured mobility values from different measurement conditions performed by an electrophoretic mobility instrument, in accordance with other embodiments.

FIG. 9 is a graph of results of an asymmetric flow field flow fractionalization process including an electrophoretic mobility instrument, in accordance with some embodiments.

FIG. 10 depicts a computer system in accordance with some embodiments.

### DETAILED DESCRIPTION

In brief overview, embodiments of the present inventive concept include an electrophoretic mobility instrument that combines the modularity of a fiber interferometer with the parallelism of a free space detection instrument so that the instrument can measure multiple angles simultaneously and measure small diffusing molecules much faster than a convention interferometer, which only measures a single angle.

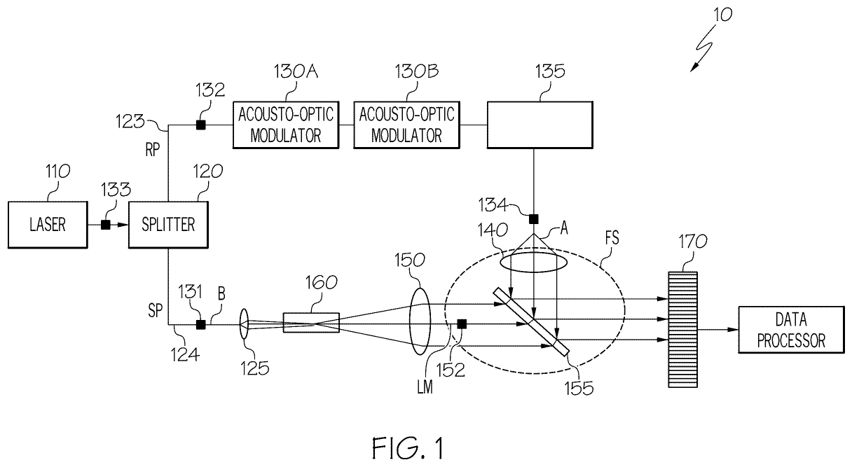

FIG. 1 is a schematic diagram of an electrophoretic mobility instrument 10, in accordance with some embodiments. In some embodiments, as shown in FIG. 1, the electrophoretic mobility instrument 10 includes a light source 110, a fiber splitter 120, and one or more laser beam modulators 130, a set of lenses 125, 140, and/or 150 and/or additional or related optical elements, a free space beam splitter 155, a sample cell 160 or related measurement cell, flow cell, or sample holding device, and a detector array 170. The electrophoretic mobility instrument 10 is constructed and arranged to operate as a fiberoptic interferometer with a parallel, free space electrophoretic mobility detector.

In some embodiments, the light source 110, e.g., laser, laser beam modulators 130, fiber splitter 120, and beam splitter 155 are positioned in a temperature-controlled enclosure. The light source 110, a splitter 120, and laser beam modulators 130 may be collectively part of a launch optics temperature control region of the instrument 10. The sample cell 160 or related sample holding device may be part of a cell temperature control region. Elements 140-170 may be collectively part of a collection optics temperature control region, or alternatively can be part of the launch optics temperature control region. The enclosure can be self-contained with only two optical fiber connections 131, 132. In some embodiments, the fiber connections 131, 132 allow the splitter 120 to be removably coupled to the upper and lower arms, respectively. The fiber connections 131 and 132 can operate as couplers for ease of assembly. In some embodiments, another coupler 133 is provided to allow detaching the laser. In other embodiments including the absence of couplers 131-133, fusion splicing or other techniques may be used to simplify the design and the expense of reduced serviceability.

The first fiber connection 131 brings light to the sample cell 160 containing a fluid sample comprising a suspension of molecules whose mobility is to be measured. The second fiber connection 134 brings local oscillator light to the reference beam expander 140, which is positioned for expanding a beam that matches the angular range of scattered light from the cell 160.

In some embodiments, the one or more laser beam modulators 130 includes one or more acousto-optic modulators (AOMs) 130A, 130B (generally, 130), but not limited thereto. In other embodiments, an optional fixed or variable attenuator 135 may extend from the AOMs to an end of the fiber 134. AOMs operate most efficiently at radio frequencies, such as 80 MHz. The AOMs 130 modulate the frequency of the reference beam so that when there is no Doppler shift in the scattered light the interference pattern sweeps across the detectors 170 at a frequency set by the AOMS 130. This signal is easily measured by a digital-to-analog converter or the like. When the sample acquires a Doppler shift from the electrophoretic motion, the frequency measured by 170 is increased (or decreased) proportionally. When the applied electric field is reversed, the frequency shift from the Doppler shift also reverses. Therefore, by measuring the frequency with a positive electric field applied and subtracting the frequency measured with a negative electric field, one can cancel Doppler shifts that are related to convection or flow through the cell. In other embodiments, instead of a dual-AOM configuration, the instrument 10 includes a single electro-optic modulator (EOM) operating as a Serodyne modulator or the like.

In some embodiments, the light source 110 is a long coherence length (single longitudinal mode) laser. The coherence length exceeds the path length difference between the reference and sample arms of the interferometer. The light source 110 is coupled into an optical fiber, for example, a single-mode, polarization-maintaining optical fiber. The incident light from the light source 110 is split into two arms by a fiber splitter 120, the two arms including a reference fiber portion 123 and a sample fiber portion 124. The reference arm is modulated by AOMs 130A and 130B. As described herein, the fiber splitter 120 is used so that one of the two beams of light extends along one path and passes through the cell and acquires a Doppler shift and the other beam takes a separate path and is frequency modulated. The sample arm beam output from the fiber is projected or focused by lens 125 onto the flow cell 160. Light scattered by the molecules or particles is collected over a range of angles by lens 150. The sample and reference arms are recombined in free space (FS) by beam splitter 155 where they interfere, completing the interferometer. The resulting interference pattern is projected onto detector 170, where each element collects light that scattered from a difference angle within the cell 160.

Only a small fraction of the light projected into the sample cell 160 is scattered by the sample, typically 10⁻⁵ to 10⁻³ of the light incident. While any split ratio can be chosen for 120, to achieve the maximum sensitivity one typically uses a split ratio of 85%-95% so that the majority of the light is projected into the sample path with the rest used for the reference path. In some embodiments, a fiber collimator 125, e.g., a collimating lens, is along the lower arm (SP) that directs the light into the measurement cell 160, for example, focusing the sample beam at the center of the sample cell 160. In some embodiments, the cell 160 is temperature controlled, described in greater detail below. In a preferred embodiment of the invention, the internal region of the sample cell 160 is accessible to fluid flow through an inlet port (not shown) and an outlet port (not shown), thus allowing the sample contained therein to be changed without the need to remove the cell 160.

The serial AOM embodiment includes a first AOM 130A and a second AOM 130B extending along the reference fiberoptic path (RP). The local oscillator light travelling along the reference path (RP) is modulated by the AOMs 130. One of the AOMs 130, e.g., the first AOM 130A may boost the frequency by +f and the other AOM, e.g., the second AOM 130B may reduce the frequency by −f+δf, where f corresponds to a radio frequency for which the AOM has a high efficiency (typically 80 MHz to 200 MHz) and the difference frequency δf is in the audio (1 kHz to 50 kHz). The net result is that the light in the two arms, when interfered, forms a heterodyne signal whose intensity oscillates at a frequency δf, which is slow enough that it can be digitized by an analog to digital converter (ADC) (not shown) for subsequent processing by a computer.

For example, the output of the laser and AOMs can be detected by a photodetector (PD) and acquired using a high-speed analog-to-digital converter (ADC) (not shown) of a spectrum analyzer (ESA) or other instrument. To measure the sample mobility, an electric field is applied to the sample inside the optical cell 160. The electric field causes the charged molecules to move. The motion creates a Doppler shift in the scattered light, which shows up in the heterodyne interferometer 10 as an additional frequency shift around the nominal frequency δf. Diffusion due to Brownian motion causes the frequency spectrum to broaden. The frequency shift therefore measures the mean velocity that develops in response to the applied field and the peak width measures the diffusion constant. To prevent bulk electrophoretic separation, the electric field is switched at around 5-20 Hz. This is fast enough to prevent bulk migration and to prevent electro-osmotic flow, driven by the wall charges, from developing. When the applied field is positive, the Doppler shift due to electrophoresis will shift the heterodyne frequency to δf+Δ, where Δ is the measurement of interest. When the applied field is negative, the heterodyne frequency will appear at≠#δf−Δ. Therefore, one can determine 24 as the difference in center of the positive and negative field spectra. This can then be converted to the mean drift velocity, which combined with the known electric field, measures the electrophoretic mobility.

Here, the interferometer 10 operates in free space (FS), i.e., air, vacuum, or the like rather than an optical fiber. Light in the upper arm (RP) is again modulated with the dual AOM scheme 130, or single EOM. The light from the optical fiber is collimated by using a collimating lens 140 used for forming a plane parallel beam. The upper beam forms a frequency shifted local oscillator. In the lower arm (SP) of the interferometer, light from the cell 160 is collimated with an objective lens 150, e.g., an asphere or the like. The center beam is referred to as the laser monitor (LM) or unscattered light since it comes from light that passed through the cell 160 without scattering. Since the scattered light is typically much weaker than the main beam LM, there may be an attenuator 152 on the beam LM to ensure that the LM signal does not saturate the detector 170. Scattered light that emerges from the cell 160 at a finite angle is collimated to form the scattering arm of the interferometer 10. More specifically, as the focused sample beam traverses the sample cell 160, a portion of the light is scattered from the particles undergoing electrophoresis. That fraction of the scattered light that can leave the sample cell 160 along with the unscattered sample beam LM are then collimated by lens 150 to form a combined collimated sample beam whose unscattered component may be attenuated by the attenuator 152 before combining with the collected scattered fraction.

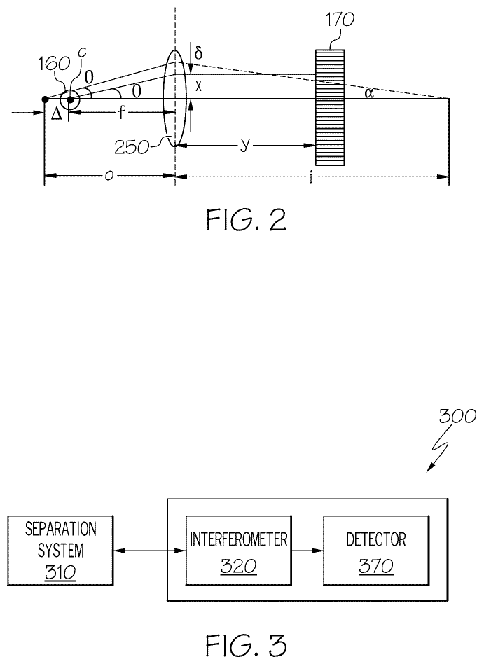

The two free space beams are combined with the beamsplitter 155. Light from the local oscillator arm (i.e., output from AOMs 130) reflects from one surface of the beamsplitter 155 and light from the scattering (i.e., output from the cell 160) is transmitted through the beamsplitter 155. The resulting interference pattern is incident on a photodiode array detector 170. In some embodiments, the plurality of photo detector elements is arranged in a one dimensional array, which can be read out in parallel resulting in an improvement in signal processing. In other embodiments, plurality of photo detector elements is arranged in a two dimensional array. Each element of the array corresponds to the heterodyne interference of light that scattered at different angles from the sample cell 160. For example, each array element intercepts a solid angle of scattered light and a range of corresponding scattering vectors, which are determined by the focal length of the lens 150, described in greater detail with respect to FIG. 2. The unscattered portion of the now collimated sample beam may be attenuated as may be required before reflecting a portion thereof at the beamsplitter 155.

The pattern that appears on the array sensor forms a series of coherent speckles. If one chooses the size of the array elements so that each spans one or more speckles, then each element forms a separate independent measurement of the scattering process. Compared to a detector with a single element, the detector 170 in accordance with embodiments of the present inventive concept makes n independent measurements, where n is the number of elements. Correspondingly the statistical accuracy improves as √n. Alternatively, one can think of the benefit as an effective increase in measuring speed. If a single detector needs a time/to produce data of acceptable accuracy, the instrument 10 having the detector 170 will produce the same quality data in a time t/n. The improvement in measurement speed is important when dealing with fragile samples. Electrophoresis requires an electrical current to be applied to the measurement cell 160. It often happens that fragile samples will degrade during the measurement. Therefore, the instrument 10 is faster and provides statistically accurate results before the sample degrades.

The voltages of each element of the photodiode array of the detector 170 can be digitized with at least one ADC (not shown). In some embodiments, the ADC is a single ADC that is multiplexed to sample all the elements. In other embodiments, parallel ADCs are used to independently digitize each element (or groups of elements). With the multiplexed ADC, the sampling speed per element is the raw sample rate divided by the number of elements. This limits that practical number of elements that can be sampled. For example, configured ADCs may run at 1 Msample/sec, and sample thirty one (31) elements so the effective sample rate per element is limited to 31 ksample/sec (or lower if other signals are also measured). If one uses the parallel ADC approach, the total number of elements is essentially unlimited. It is feasible to measure hundreds, or thousands, of elements to achieve a corresponding increase of speed. Typical measurement times for a sample may be around 30 seconds, but not limited thereto. With a 100 resolved elements, the same data quality would be achieved in 0.3 seconds. Alternatively, if one kept the acquisition time of 30 seconds, the resulting data would have 10× lower noise.

In some embodiments, the fiber components of the interferometer 10 are single-mode polarization maintaining fibers. The individual fiber segments can be connected with optical fiber couplers, or permanently connected with fiber fusion splicing.

In some embodiments, in the local oscillator arm along path RP, the light diverges from the fiber, which terminates at position A, and is collimated by a lens system including the collimating lens 140 to form a plane parallel beam. The lens 140 is placed at a distance to form a collimated beam that is wide enough to match the range of scattering angles collected from and collimated by the cell 160.

In some embodiments, this is achieved by having replacing lens 140 with a Galilean telescope with two lenses, where the first lens is a diverging lens followed by a converging lens to form a parallel beam. However, in preferred embodiments, the diverging lens is not required since the light naturally diverges when exiting the fiber. The presence of additional optical elements such lenses is not desirable due to complex calibration and manufacturing requirements. The divergence angle is set by the numerical aperture of the fiber (typically around 0.2). In some embodiments, the instrument 10 includes a linear sensor so the Galilean telescope is made with cylindrical lenses to form a parallel beam with an elliptical cross section that spans the width of the sensor array. Since the instrument 10 uses a fiber in lieu of the diverging lens, the resulting beam at location A shown in FIG. 1 will have a circular cross section which would match well to a 2D array. The ends of this fiber are shown in FIG. 1 at locations A and B. In embodiments where a linear detector array is used, a pair of cylindrical lens may be used to accomplish a desire beam shaping and produce a plane parallel beam with an elliptical cross section to obtain a reference beam providing economical use of available optical power, for example, described in U.S. Pat. No. 8,525,991 incorporated by reference above.

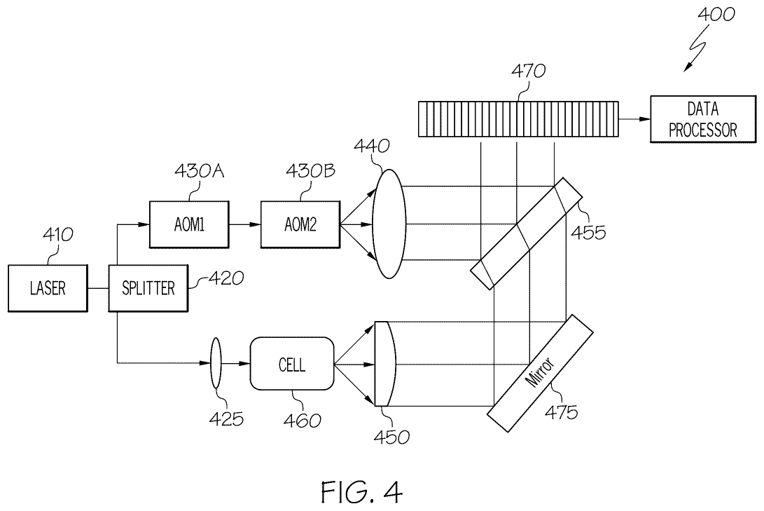

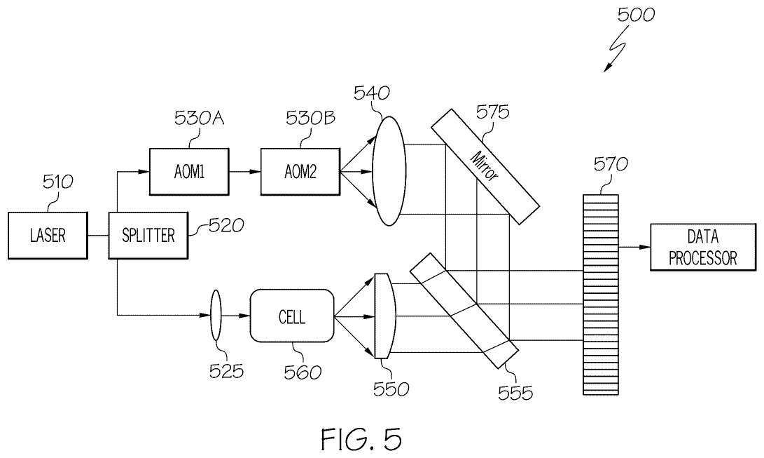

During operation, in the sample arm (SP), the low angle scattered light is collimated by a large collimating lens 150 to form a parallel beam. In some embodiments, this beam may be directed to a mirror and then the scattered beam and the local oscillator beams are combined with a beamsplitter that functions as a combiner as described in FIGS. 4 and 5. If the local oscillator light and the scattered light are properly aligned, they will interfere and each pixel on the array sensor will correspond to a different scattering angle. The data can be collected and processed so that each element of the detector array 170 will generate an optical spectrum of the scattering and doppler shifted light from the sample. Although not shown, a data processor in communication with the detector can measure the light intensity scattered from the moving molecules. In some embodiments, the data processor may measure the light intensity values of beams formed by the beamsplitter combining the reference beam with the collimated fraction of light sampled from a sample aliquot, wherein the photo detector elements are placed in the path of the beam. For example, the data processor can convert the light intensity values measured at each photodetector element into digital representations.

In conventional systems, for example, described in U.S. Pat. No. 8,525,991 incorporated by reference above, the interferometer bench is temperature controlled from 4 C to 70 C and is contained inside a thermally insulating enclosure that is filled with a dry gas bleed to prevent condensation when it is run below the dew point. The laser cannot tolerate the wide temperature range of the interferometer, so it may be housed in a separate enclosure and the light is projected into the interferometer, i.e., the splitter, through a window. It is difficult to ensure that the two enclosures remain aligned over the operating temperature range. This requires the two enclosures to be rigidly mounted on an alignment plate with low thermal expansion standoffs. This adds substantially to the weight of the instrument and limits the temperature range over which it can be operated.

Accordingly, the instrument 10, in accordance with some embodiments eliminates the need to maintain optical alignment between a laser compartment and the interferometer compartment. Instead, the laser 110 is coupled into an optical fiber so there is the freedom to position the laser as desired. Here, the laser 110, fiber splitter 120, and AOMs 130 are housed in a temperature regulated enclosure for best stability. However, there is no need to maintain optical alignment between the two. The instrument 10 improves manufacturability and serviceability over the instrument of the conventional systems since if the laser 110 or an AOM 130 becomes defective or otherwise needs to be replaced, they can be replaced as service components without requiring the rest of the interferometer to be realigned.

FIG. 2 is a schematic diagram of a layout of a sample cell 160 and a detector 170 of the electrophoretic mobility instrument of FIG. 1, in accordance with some embodiments.

The layout shown in FIG. 2 illustrates the manner in which an optimal location of the detector array 170 can be determined. For simplicity, the bending of light at the interface of the flow cell 160 and the offset in the beamsplitter/recombiner 155 are not shown. A collimated beam, of roughly 100 μm diameter is projected into the sample cell 160. A large collimating lens 250 is placed one focal length from the center (c) of the cell 160 so that light that scatters from the center of the cell 160 makes a plane parallel beam on the right side of the lens 250. The lens 250 can be similar to the lens 150 described with respect to FIG. 1, and illustrated the position of a received beam of light relative to a center of the cell 160. Light that is emitted at an angle θ arrives at the sensor a distance x from the center of the array 170. As shown, the sensor 170 is a distance y from the lens 250. Since the scattered light forms a plane parallel beam, the sensor 170 can be placed at any distance from the lens 250 and y is undetermined.

However, the scattered light is not emitted only from the center (c) of the cell 160. The beam forms a line source along the x axis. Consider light that scatters at angle θ, but starting a distance Δ, from the center of the cell 160. This ray travels parallel to the previous ray and arrives at the lens a distance δ from the previous ray. However, since the ray is not emitted at the focal distance from the lens 250, it will form an image a distance i from the lens 250. One can use the thin lens law to determine i via

$$\frac{1}{f} = \frac{1}{i} + \frac{1}{o} ,$$

where o=f+Δ. Furthermore, if the ray is required to start at o to arrive at the sensor 170 at the same location x as the focal ray, this determines the optimal distance y=f for small values of Δ. In other words, if the sensor 170 is located one focal distance to the right of the lens 250, then a short line source at the center of the cell 160, scattered at angle θ will be collected into a single pixel. If the light source is large so that the Δ is not small (compared to f), the light at θ, will leak into neighboring detector channels.

In considering this effect, also considered is the recombination in free space of the local oscillator beam with the scattered beam. If the scattered light is only emitted from the center (c) of the cell 160, it would form a plane parallel beam at the detector 170. The local oscillator beam, which is formed by collimating light emitted from the fiber, is also a plane parallel beam. The interference of the two will make large interference fringes. Light that is emitted from the cell 160 at angle θ at a distance Δ will create a spherical wave front, which when interfered with the local oscillator plane, will form a series of circular fringes. The larger that Δ becomes, the more closely spaced are the fringes. When they become so close that multiple fringes are captured by a single pixel and there will be a cancellation of the signal. The net effect is that there is a depth-of-field effect inside the cell 160 for which the instrument 10 will be sensitive to the moving particles. By putting the detector 170 at one focal length from the collimating lens 250, the depth of field is maximized, and the mixing of light scattered at different angles being collected into a single detector element is minimized.

FIG. 3 is a block diagram of an electrophoretic mobility instrument 300, for example, shown in FIGS. 1 and 2, operating as an online mobility detector with a separation system 310, in accordance with some embodiments. As an online detector 300, mobility measurements are made in a branch of a process into which samples of the substance to be measured are fed, for example, described in U.S. Pat. No. 10,983,089, entitled “Method to Measure Electrophoretic Mobility of a Flowing Sample,” the entirety of which is incorporated herein by reference.

In some embodiments, the separation system 310 can include a field flow fractionalization (FFF) or size exclusion chromatography (SEC) system, but not limited thereto. During operation, a solution containing solutes such as molecules, e.g., proteins, or viruses, nanoparticles, liposomes, etc. received by the interferometer 320 from an SEC column or the like of the separation system 310 are measured online by the mobility detector 30 following separation by the separation system 310. The interferometer 310 may be similar to that shown and described in FIG. 1, for example, including a light source 110, fiber splitter 120, modulators 130, beamsplitter 155, and so on. The interferometer 320 can detect characteristics such as a velocity of the particles in the solution by directing beams of coherent radiation from the source along the sample path (SP) and reference fiber optic path (RP) test, which pass through the sample fluid under test. The optical components at the end of the interferometer 320 may comprise recombination means for interferingly recombining radiation scattered into identical angles from both paths and thereby forming interference fringes which indicate the local velocity of the fluid under test, and are observed by the detector 370. The detector 370 may be similar to the detector 170 described in FIGS. 1 and 2, so details are not repeated for brevity.

FIG. 4 is a block diagram of an electrophoretic mobility instrument 400, in accordance with other embodiments. In some embodiments, the electrophoretic mobility instrument 400 includes elements similar to those of the instrument of FIGS. 1-3 such as a laser 410, laser beam modulators 430, reference path collimating lens 440, beamsplitter 455, detector array 470, sample path collimating lens 425, and sample cell 460. For example, the electrophoretic mobility instrument 400 may be used with the separation system 310 of FIG. 3.

However, electrophoretic mobility instrument 400 is constructed and arranged so that the array sensor 470 is in communication with the sample cell 460. As the focused sample beam traverses the sample cell 460, a portion of the light is scattered from the particles undergoing electrophoresis. The fraction of the scattered light that can leave the sample cell 160 through an exit window along with the unscattered sample beam are then collimated by a condenser lens 450, e.g., an asphere lens or the like similar to lens 150, 550 herein, to form a combined collimated sample beam whose unscattered component may be attenuated by an attenuator means before combining with the collected scattered fraction to reflect from mirror 475. These reflected components are then further reflected from beamsplitter 455 to fall upon the detector array 470. The mirror 475 and beamsplitter 455 achieve co-linearity between the collimated scattered sample beam with its unscattered component and the reference beam for optimal optical mixing/heterodyning at the detector array 470. Each array element intercepts a solid angle of scattered light and a range of corresponding scattering vectors, which are determined by the focal length of the condenser lens 450 as well as the positions and dimensions of the detector array elements. The unscattered portion of the now collimated sample beam may be attenuated as required before reflecting a portion thereof at the beamsplitter 455 to be incident upon a particular array element that will serve as the sample beam monitor.

FIG. 5 is a block diagram of an electrophoretic mobility instrument 500, in accordance with other embodiments. In some embodiments, the electrophoretic mobility instrument 500 includes elements similar to those of the instrument of FIGS. 1-4 such as a laser 510, laser beam modulators 530, reference path collimating lens 540, beamsplitter 555, detector array 570, sample path collimating lens 525, and sample cell 560. In addition, the electrophoretic mobility instrument 500 may include a condenser lens 550 and mirror 575 similar to condenser lens 450 and mirror 475 in FIG. 4. FIG. 5 illustrates and describes an alternative configuration where the mirror 575 is along the reference path to the beamsplitter 555 and the beamsplitter 555 is along the sample path from the cell 160.

Referring again to the electrophoretic mobility instrument 300 of FIG. 3, an experiment was performed with the instrument 300 having 31 simultaneous detectors 370. In this experiment, three conditions were compared for three test proteins: Thyroglobulin, Bovine Serum Albumin (BSA), and Carbonic Anhydrase (CA). These proteins differ in their size, molar mass, and mobility. They also differ substantially in their individual purities.

The first test condition was a control. Each sample was prepared and measured without flow, one at a time. This is the usual batch measurement technique. In the second test, each sample was individually injected into a SEC column of the separation system 310 and the fractionated sample was measured online. The SEC separated the aggregates and impurities into separate peaks and dialyzed the sample against the chromatography mobile phase. In the last test, all the samples were mixed and then injected into the column, which then fractionated them into their constituents.

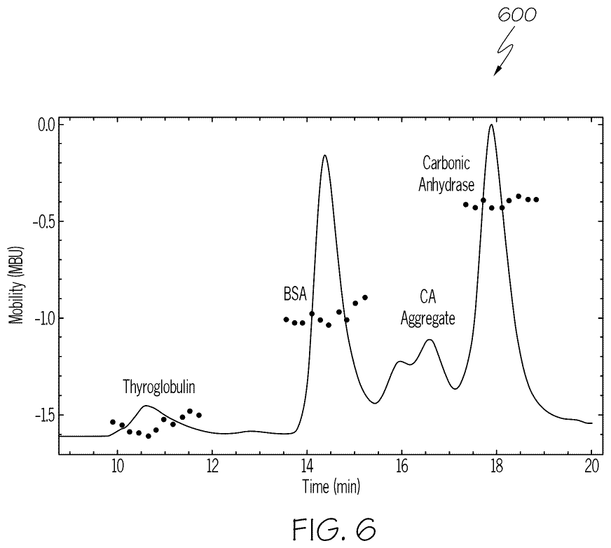

FIG. 6 is a graph 600 that shows an example of the mixture eluting from the column. On the left axis is the mobility value measured during the elution. Overlaid is the differential refractive index (DRI) of the sample (in arbitrary units). Each sample has a different refractive index increment dn/dc, but the DRI signal is proportional to the concentration of each sample. Since the flow cell 160 is relatively large (approximately 200 ul), it was not possible to put the DRI detector after the mobility detector 300 without excessive peak broadening and the DRI detector too has a large internal volume so that it could not be connected before the online detector 300. Therefore, the graph in FIG. 6 is constructed by composing separate runs for the online-mobility measurement (without the DRI) and the for the DRI measurement (without the online detector 300). In some embodiments, a lower volume cell is used to make it feasible to measure these signals simultaneously.

The first observation is that the mobility of each species is clearly measured except for the aggregate of Carbonic Anhydrase, for which the signal to noise was too low. The second observation is that because since the DRI signal for each species is measured, one can determine the concentration of each species, and therefore derive a mobility spectrum, which is the weight fraction of the sample with a given mobility value. Each species in the sample had a well different mobility value so each peak corresponds to each of the different samples.

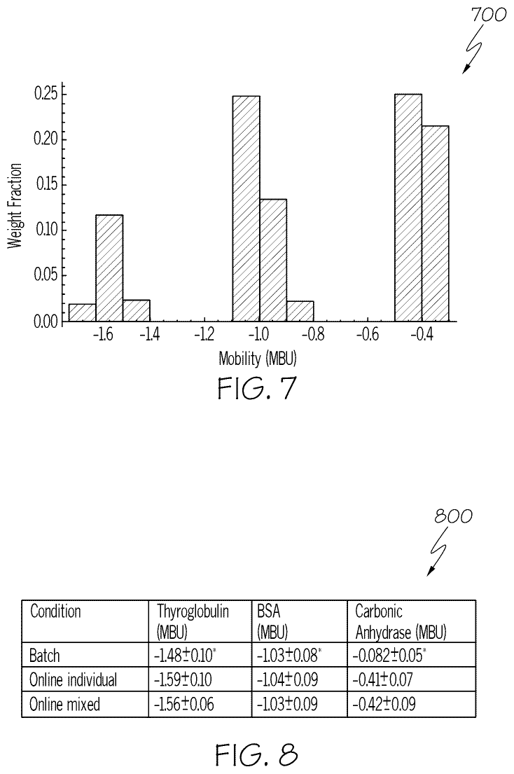

FIG. 7 is a graph 700 illustrating a mobility spectrum showing a weight fraction of each mobility range. As shown, the comparison of the measured mobility values from different conditions: batch, online individual, and online mixed, is revealing. The results of the comparison of mobility values from each measurement condition are summarized in the table 800 in FIG. 8.

In particular, the BSA sample (see FIG. 6) shows essentially same mobility of −1.03 to −1.09 MBU in all three configurations. The bar graph in FIG. 7 is derived from the data in FIG. 6. The height each bar is the sum of all of the mass, as measured by the overlaid RI detector, that has a given mobility. Since we have three resolved mobility clusters in FIG. 6, 3 bars result as shown in FIG. 7.

This is because the BSA sample was highly monodisperse, with very little aggregate content. In contrast, the CA in the batch measurement was around −0.82 MBU but only −0.41 MBU for both of the chromatography fractionations. The interpretation is that by separating the aggregated CA from the monomer, the chromatography runs give the true monomer mobility. The batch measurement averages the aggregate and monomer mobilities together and thereby produces a dramatic overestimate of the monomer mobility. It is worth noting that the CA run showed a distinct aggregate peak but the concentration was too low to get an independent aggregate mobility value. The Thyroglobulin measurements show the same effect, but smaller in magnitude. This example demonstrates the compelling benefit of performing mobility measurements with fractionation. Without the ability to measure the fractioned sample, one would make a serious error in interpreting the results of the CA sample. In general, it is impossible to know from the batch-only measurement whether the results were due to the pure monomer or not. The effect is worse when the sample itself is polydisperse.

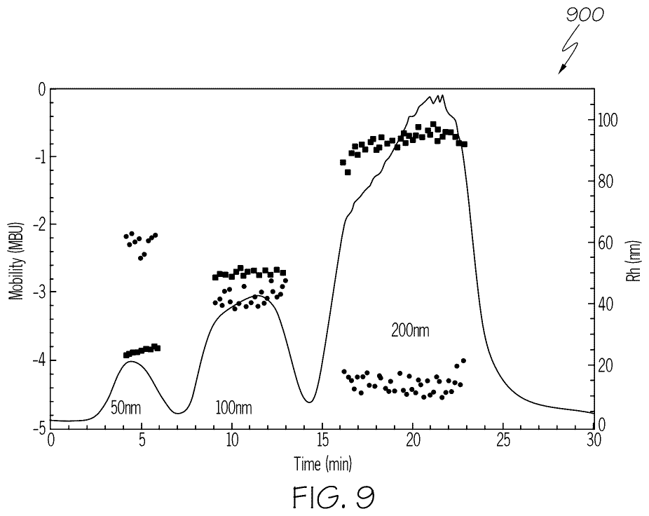

In some embodiments, the same type of online mobility measurement can be performed by an instrument in FIGS. 1-5 for particle fractions. In the following example, a mixture of three different polystyrene latex (PSL) size standards were fractionated by asymmetric flow field flow fractionation performed by the separation system 310 in FIG. 3. The sample consisted of a mixture of 50 nm, 100 nm, and 200 nm diameter standards. The results of the fractionation were analyzed online with mobility, MALS with dynamic light scattering (DLS), and/or DRI instruments, for example, in communication with, or part of, the instrument 300 shown in FIG. 3. The results are summarized in FIG. 9. On the left axis is the measured mobility values. On the right axis is the hydrodynamic radius of the particles as reported by online DLS. Overlaid is the DRI signal in arbitrary units. As with the SEC example above, the species are well fractionated and for each sample the size and mobility are well measured. The sloping size for the 50 nm standard shows that it was slightly polydisperse and the subfractions were separated.

Accordingly, as described herein, flow-mode mobility measurements can be directly coupled with numerous separation techniques to characterize the electrophoretic mobility of each eluted species separately. Here, an interferometer can be used for online measurements while providing parallel free-space detection features. Applications may include size-exclusion chromatography, ion-exchange chromatography, and field-flow fractionation, but not limited thereto.

The experimental data above was collected with a conventional free space interferometer with parallel detection but required high concentration samples to achieve reasonable signal to noise of online detection of fractionated samples. The invention has the benefit of improving measurement speed and accuracy which makes the online measurement practical for lower concentration samples. Moreover, as elements are added to the array, for example, 100-1000, the interferometer the performance increases correspondingly.

As mentioned above, the existing flow cell has a flow cell volume that is large enough that downstream detectors would see broadened peaks. It is straightforward to reduce the cell volume to address this, but then the optical mobility signal would also be reduced. Again, the increased sensitivity afforded by the parallel detection method counteracts the reduced sensitivity of a low volume cell. The reduction in measurement time ensures that fragile samples are not degraded before the measurement is completed. The instrument eliminates many of the optical elements required of complex detection systems, reducing the cost and complexity of the product.

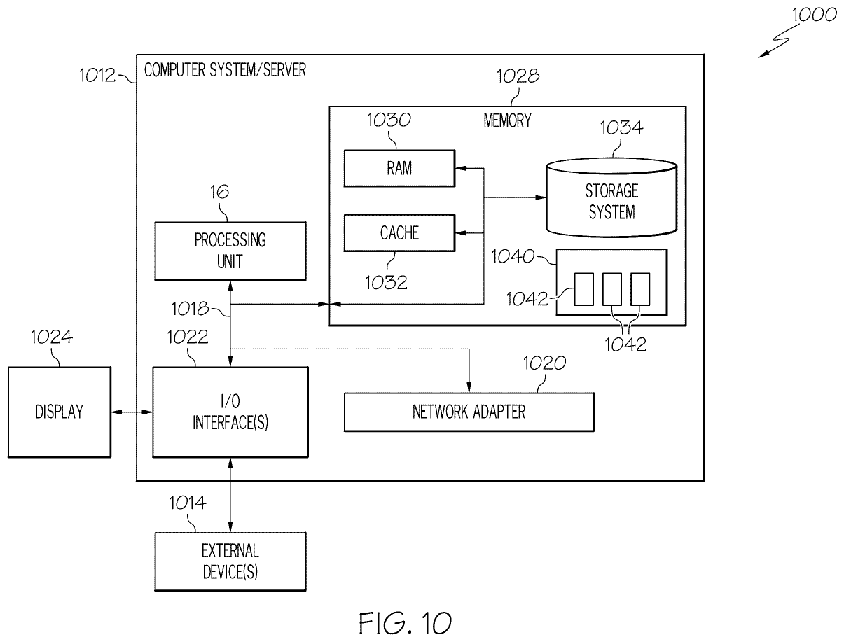

FIG. 10 depicts a computer system 1000 in accordance with an exemplary embodiment. In an exemplary embodiment, the computer system 1000 is a standalone computer system, a network of distributed computers, or a cloud computing node server. Computer system 1000 is only one example of a computer system and is not intended to suggest any limitation as to the scope of use or functionality of embodiments of the present disclosure. Regardless, computer system 1000 is capable of being implemented to perform and/or performing any of the functionality/operations of the present disclosure.

Computer system 1000 includes a computer system/server 1012, which is operational with numerous other general purpose or special purpose computing system environments or configurations. Examples of well-known computing systems, environments, and/or configurations that may be suitable for use with computer system/server 1012 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 1012 may be described in the general context of computer system-executable instructions, such as program modules, being executed by a computer system. Generally, program modules may include routines, programs, objects, components, logic, and/or data structures that perform particular tasks or implement particular abstract data types. Computer system/server 1012 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, the components of computer system/server 1012 may include, but are not limited to, one or more processors or processing units 1016, a system memory 1028, and a bus 1018 that couples various system components including system memory 1028 to processor 1016. The data processor of FIGS. 1-5 may include some or all of the components described with reference to the computer system 1000.

Bus 1018 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1012 typically includes a variety of computer system readable media. Such media may be any available media that is accessible by computer system/server 1012, and includes both volatile and non-volatile media, removable and non-removable media.

System memory 1028 can include computer system readable media in the form of volatile memory, such as random access memory (RAM) 1030 and/or cache memory 1032.

Computer system/server 1012 may further include other removable/non-removable, volatile/non-volatile computer system storage media. By way of example only, storage system 1034 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1018 by one or more data media interfaces. As will be further depicted and described below, memory 1028 may include at least one program product having a set (e.g., at least one) of program modules that are configured to carry out the functions/operations of embodiments of the disclosure.

Program/utility 1040, having a set (at least one) of program modules 1042, may be stored in memory 1028 by way of example, and not limitation. Exemplary program modules 1042 may include an operating system, one or more application programs, other program modules, and program data. Each of the operating system, one or more application programs, other program modules, and program data or some combination thereof, may include an implementation of a networking environment. Program modules 1042 generally carry out the functions and/or methodologies of embodiments of the present disclosure.

Computer system/server 1012 may also communicate with one or more external devices 1014 such as a keyboard, a pointing device, a display 1024, one or more devices that enable a user to interact with computer system/server 1012, and/or any devices (e.g., network card, modem, etc.) that enable computer system/server 1012 to communicate with one or more other computing devices. Such communication can occur via Input/Output (I/O) interfaces 1022. Still yet, computer system/server 1012 can communicate with one or more networks such as a local area network (LAN), a general wide area network (WAN), and/or a public network (e.g., the Internet) via network adapter 1020. As depicted, network adapter 1020 communicates with the other components of computer system/server 1012 via bus 1018. It should be understood that although not shown, other hardware and/or software components could be used in conjunction with computer system/server 1012. Examples include, but are not limited to microcode, device drivers, redundant processing units, external disk drive arrays, RAID systems, tape drives, and data archival storage systems.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiberoptic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. An electrophoretic mobility apparatus, comprising:
a light source;
a sample fiberoptic path along which a first source of light including a sample beam travels from the light source;
a sample cell along the sample fiberoptic path that receives the first source of light, wherein the sample beam passes through the sample cell as an unscattered portion, and a scattered fraction of the sample beam scatters from particles in an aliquot in the sample cell;
a reference fiberoptic path along which a second source of light including a reference beam travels from the light source;
a lens along the reference fiberoptic path that forms a plane parallel beam from the second source of light;
at least one modulator along the reference fiberoptic path that provides frequency control of the second source of light;
a beamsplitter in free space that combines the reference beam with the scattered fraction of the sample beam and forms a coherent beam; and
a detector comprising an array of photo detector elements onto which the coherent beam is incident, wherein each detector element produces time varying signals from the coherent beam.

2. The electrophoretic mobility apparatus of claim 1, further comprising:
a fiber splitter that includes a first output port to the sample fiberoptic path and a second output port to the reference fiberoptic path;
a first removable coupling between the second output port of the fiber splitter and the sample cell; and
a second removable coupling between the first output port of the fiber splitter and the at least one modulator.

3. The electrophoretic mobility apparatus of claim 1, further comprising a collimating lens that directs the first source of light into the sample cell.

4. The electrophoretic mobility apparatus of claim 1, further comprising a collimating lens at an output of the at least one modulator that directs the second source of light into the beamsplitter.

5. The electrophoretic mobility apparatus of claim 1, further comprising a collimating lens at an output of the sample cell that forms a parallel beam from the first source of light directed at the beamsplitter, the collimating lens collimating the scattered fraction of the sample beam and the unscattered portion of the sample beam.

6. The electrophoretic mobility apparatus of claim 1, further comprising a mirror that reflects the unscattered portion of the sample beam combined with the scattered fraction to the beamsplitter.

7. The electrophoretic mobility apparatus of claim 1, further comprising a mirror that reflects the reference beam to the beamsplitter.

8. The electrophoretic mobility apparatus of claim 1, wherein the collimating lens is positioned one focal length from a center of the cell so that light that scatters from the center of the cell makes a plane parallel beam from the lens to the detector.

9. The electrophoretic mobility apparatus of claim 1, further comprising a data processor that measures light intensity values of the coherent beam from the beamsplitter, the light intensity values at each of a plurality of photo detector elements placed in the path of the coherent beam.

10. The electrophoretic mobility apparatus of claim 1 wherein said sample cell is an interchangeable unit.

11. The electrophoretic mobility apparatus of claim 1, wherein the detector comprises a two-dimensional array.

12. The electrophoretic mobility apparatus of claim 1, wherein the detector comprises a one-dimensional array.

13. An electrophoretic mobility apparatus, comprising:
a fiberoptic interferometer that divides a coherent monochromatic light beam into a sample beam that passes through a sample and a reference beam, the fiberoptic interferometer including:
a reference arm having at least one modulator that provides frequency control of the reference beam; and
a sample arm having a sample cell that holds the sample; and
a parallel, free space detection system comprising:
a beamsplitter in free space that combines the reference beam with a fraction of light scattered from the particles and forms a coherent beam; and
a detector comprising an array of photo detector elements onto which the coherent beam is incident, wherein each detector element produces time varying signals from the coherent beam.

14. The electrophoretic mobility apparatus of claim 13, further comprising:
a fiber splitter that includes a first output port to the reference arm and a second output port to the sample arm.

15. The electrophoretic mobility apparatus of claim 14, further comprising a collimating lens that directs the sample beam into the sample cell.

16. The electrophoretic mobility apparatus of claim 13, at least one modulator that provides frequency control of the reference beam;

17. The electrophoretic mobility apparatus of claim 16, further comprising a collimating lens at an output of the at least one modulator that directs the reference beam into the beamsplitter.

18. The electrophoretic mobility apparatus of claim 13, further comprising a collimating lens at an output of the sample cell that forms a parallel beam from the sample beam directed at the beamsplitter, the collimating lens collimating the scattered fraction of the sample beam and the unscattered portion of the sample beam.

19. The electrophoretic mobility apparatus of claim 13, further comprising a data processor that measures light intensity values of the coherent beam from the beamsplitter, the light intensity values at each of a plurality of photo detector elements placed in the path of the coherent beam.

20. An apparatus, comprising:
a laser;
a fiber having an input for receiving an output of light from the laser;
a fiber splitter;
first and second acousto-optic modulators at a first output of the fiber splitter that transmit a reference beam of the output of light;
an optics element at an output of the first and second acousto-optic modulators;
a beam splitter in free space that combines the reference beam with a sample beam output in parallel from a second output of the fiber splitter to form a coherent beam; and
a detector that produces time varying signals from the coherent beam.
